(19) United States
(12) Patent Application Publication
(10) Pub. No.: US 2007/0261573 A1
(43) Pub. Date: Nov. 15, 2007

(54) Compactor cleaning system

(75) Inventor: Allan Ray Cameron, Drury (NZ)

Correspondence Address: YOUNG & THOMPSON, 745 SOUTH 23RD STREET, 2ND FLOOR, ARLINGTON, VA, 22202, US

(73) Assignee: Allan Ray Cameron, Drury (NZ)

(21) Appl. No.: 11/797,413

(22) Filed: May 3, 2007

(30) Foreign Application Priority Data
May 5, 2006 (NZ) 546985

(51) Int. Cl. B30B 3/04

(52) U.S. Cl. 100/174

(57) ABSTRACT

The invention resides in a compactor cleaning system comprising a compactor cleaning apparatus and cleaning plate device being located on a compactor drum or wheel of a compactor having feet thereon, to remove any debris between the feet. The drum/wheel has an outer surface or rim with spaced feet thereon. The compactor cleaning apparatus includes scraping means, supporting means, and hinging means which are supported by the compactor via the hinging means whereby the scraping means is connected to the supporting means. The hinging means is constructed and adapted to allow the compactor cleaning apparatus to move substantially vertically in a biased manner to clean or remove debris between the feet of the compactor. Each cleaning plate device includes two plates joined together at one end and splayed apart at the other end as attached to the drum surface whereby the debris is less likely to be found between the feet of the compactor.

The invention relates to a compactor cleaning system. The invention is directed particularly but not solely towards an adjustable compactor cleaning apparatus and cleaning plate device for a compactor machine.

### BACKGROUND OF INVENTION

Compactors generally comprise a wheeled vehicle having some form of compacting portions that provide concentrated surface areas especially adapted to compact various soil types and are used on large earthworks jobs or projects such as highway construction, earth dams, sub-division developments and the like. On these projects earthmoving machines such as motor-scrapers, dump trucks, bulldozers and scoops, transport soil into a fill area so that a required level can be achieved.

Compacting machines are usually large diesel powered pivot steer four wheeled units. The wheels can be referred to as drums of steel of a wide design with steel feet fitted to them. The steel feet have a concentrated surface area which is normally formed or shaped so as to protrude into the ground, thus compacting it as the machine passes over. Each foot is separated from the other teeth by a set spacing or gap. When compacting, such spaces get continuously filled with dirt or soil or debris that spills over from each foot or gets picked up from the ground when compacting is occurring. This excess of dirt requires cleaning out so that continued compaction can be achieved. The cleaning operation adds a large load on the machine and has a marked effect on productivity, fuel and labour etc.

Cleaners with blades are fixed to a sub-frame which is mounted round each wheel or drum. The cleaners are usually mounted on each side of the side of the drum so that when the machine reverses the cleaner that was trailing then becomes the effective one. The cleaner blades are usually slotted so that as they wear, they can be adjusted closer to the drum. The low efficiency of the existing designs occurs when the trailing cleaner tend to cause a high percentage of the total drag, while adding nothing to the efficiency of the compacting operation.

The discussion herein of the background to the invention is included to explain the context of the invention. This is not to be taken as an admission that any of the material referred to was published, known or part of the common general knowledge as of the priority date of any of the claims.

### OBJECT OF THE INVENTION

It is an object of the invention to provide an improved compactor cleaning system or compactor cleaning apparatus or cleaning plate device that ameliorates some of the disadvantages and limitations of the known art or at least provide the public with a useful choice.

### SUMMARY OF INVENTION

In a first aspect the invention resides in a compactor cleaning apparatus for a compactor having at least one drum/wheel with an outer surface or rim with spaced feet thereon, the cleaning apparatus including scraping means, supporting means, and hinging means whereby the scraping means is operatively connected or attached or joined to the supporting means and the supporting means is supported by the compactor via the hinging means, wherein the hinging means is constructed and adapted to allow the cleaning apparatus to move substantially vertically in a biasedly attached manner to remove at least some unwanted debris between feet or on the drum surface.

Preferably, the apparatus has an adjustment means to allow an adjustment of the distance from the scraping means to the drum/wheel rim surface.

Preferably, the scraping means includes at least one blade.

Preferably, the hinging means includes a bolt and spring attached to a compactor support beam frame.

Preferably the frame is rectangular in shape having side members, front member and rear member which frame is removably attached to a compactor drum/wheel at the sides.

Preferably the cleaning apparatus is attachable to the front member forming in use a leading scraper.

Preferably the cleaning apparatus is attached to the rear member forming in use a trailing scraper.

Preferably there is a plurality of cleaning apparatus on the front members and/or rear member of the frame.

In a second aspect the invention resides in a compactor cleaning system for a compactor in the form of a cleaning plate device comprising two plates joined together at one end and splayed apart at the other end whereby the other end is joined to a drum/wheel rim between at least two feet such that in use debris/soil has difficulty in remaining or forming between feet of a compactor.

In a third aspect the invention resides in a compactor cleaning system comprising a compactor cleaning apparatus and cleaning plate device being located on a compactor drum or wheel of a compactor having at least one drum/wheel with an outer surface or rim with spaced feet thereon, includes scraping means, supporting means, and hinging means which are supported by a compactor via the hinging means whereby the scraping means is connected to the supporting means, wherein the hinging means is constructed and adapted to allow the cleaning apparatus to move substantially vertically in a biased manner to clean or remove debris between feet, each cleaning plate device includes comprising two plates joined together at one end and splayed apart at the other end as attached to the drum surface whereby the debris is less likely to be found between the feet of the compactor.

### BRIEF DESCRIPTION

The invention will now be described, by way of example only, by reference to the accompanying drawings:

FIG. 1 is a cross sectional view of the compactor cleaning apparatus in accordance with a one preferred embodiment of the invention.

FIG. 2 is a close up perspective view of the compactor cleaning system in accordance with another preferred embodiment of the invention in the form of a compactor cleaning device.

FIG. 3 is a perspective view of the cleaning system in use on a compactor including the apparatus and device showing a plurality of each.

### DESCRIPTION OF DRAWINGS

The following description will describe the invention in relation to preferred embodiments of the invention, namely a compactor cleaning system including a compactor cleaning apparatus for a compactor C having at least one drum/wheel D with an outer surface or rim with spaced feet F thereon, a cleaning plate device 20, compactor drum/wheel tooth arrangement and system. As shown in FIG. 3 the feet F can be arranged in any suitable pattern such as in a circumferentially spaced rows S1 of feet with further smaller spaces S2 between each foot (see FIG. 2) whereby unwanted debris or soil gets lodged or deposited thereon which needs to be removed or cleaned or reduced in extent therefrom.

The invention is in no way limited to these preferred embodiments as they are purely to exemplify the invention only and that possible variations and modifications would be readily apparent without departing from the scope of the invention.

As shown in the figures there are various forms of soil compactor cleaning systems. FIG. 1, shows a compactor cleaning apparatus 1 adapted for removable fitting to the soil compactor C. The apparatus includes a scraping means 2 joined or formed with a supporting means 3. The supporting means 3 includes an arm portion which is connectable, joinable or attachable to scrapping means 2 which is connected or joined or fixed to a compactor drum/wheel support frame 4 by hinging means 5 which allows the cleaning apparatus to float or move with any type of movement of the compactor machine over the ground.

Hinging means 5 includes a biasing means comprising a bolt/nut 6 and springs 7 combinations as shown in FIG. 1. This spring construction enables the scrapping means 2 to float with the movement of the drum/wheel as required due to different ground levels, obstructions reversing and also enables the scraper to return to its position to scrape.

Scrapping means 2 is formed as at least one replaceable blade. Supporting means 3 can be separately formed with scraping means 2 or it can be integrally formed with the scrapping means 2. Supporting means 3 can include adjustment means 8 which can optionally be arranged on each blade if necessary.

Adjustment means 8 can include any form of adjustment that allows the distance from the distal end of the blade(s) to the drum/wheel rim surface or any drum/wheel surface where the soil or any other unwanted debris sticks or adheres to. In this example there is shown a series of separate holes 9 with fixing means 10. As each blade is cantilevered and biasedly attached to the support frame 4 there is hinged spring support action involved which also allows the trailing or rear cleaner portion to float away and not cause drag, from the drum D when the drum is moving in the forward direction.

Supporting means 3 is then attached to the wheel support frame 4 which can include for example at least one rectangular or square frame having side members 5, a front member 6 and rear member. Other frame shapes are possible with further added front and or rear members. These members can be any material type and/or cross section in the form of a beam with the side members 5 being removably and pivotally fixed to the compactor machine body to allow in use the frame to float or rotate somewhat, past each drum/wheel D. In this case the side members are gapped from the drum and are not directly attached to the drum so allowing the frame to move freely past the drum. Alternatively the frame can be attached to the side of the compactor drums via the drum axles.

In use the apparatus can include a front or forward cleaning portion and a rear or reverse cleaning portion and there can be at least one cleaning apparatus or several cleaning apparatus such that there is scrapping means all along a drum rim or only on a portion of the rim, as required. Alternatively there may be only a forward cleaning portion or just a rear cleaner portion from each drum or as selected. In other variations the scraping means or blade(s) can be any width or length or thickness required. For example each blade can be the full width of the drum or any portion thereof and in any number and spacing across the drum width. In use as the compactor machine moves forward and/or backwards soil tends to build up at least between the circumferential rows of feet F on the drum. Therefore the blades are mounted on the support frame 4 so as to remove the soil or at least remove some of the soil that can form between the rows of feet on each drum.

FIG. 2 shows another form of a cleaning system that can be used in combination or not with the compactor cleaning apparatus 1 which system includes a cleaning plate device 20 affixed to a compactor drum/wheel outer surface or rim. Device 20 which is tent-like in shape includes at least two plates 21 and 22 joined together when in place at one top edge 23. In use the bottom edge of plates 21 & 22 are splayed apart to provide a wedge shaped outwardly protruding volume between any adjacent feet 24 & 25. Each drum foot F can be fabricated as a boxed base section with a separate cast foot. In another option the cleaning plate device 20 can be fabricated with the feet 24 and 25 or retro fitted between each foot which can be welded or bolted to the drum or cast into them during manufacture of the machine. Any number of cleaning plate devices 20 can be fitted between feet both as shown in FIG. 2 and/or alternatively between adjacent circumferential rows of feet F.

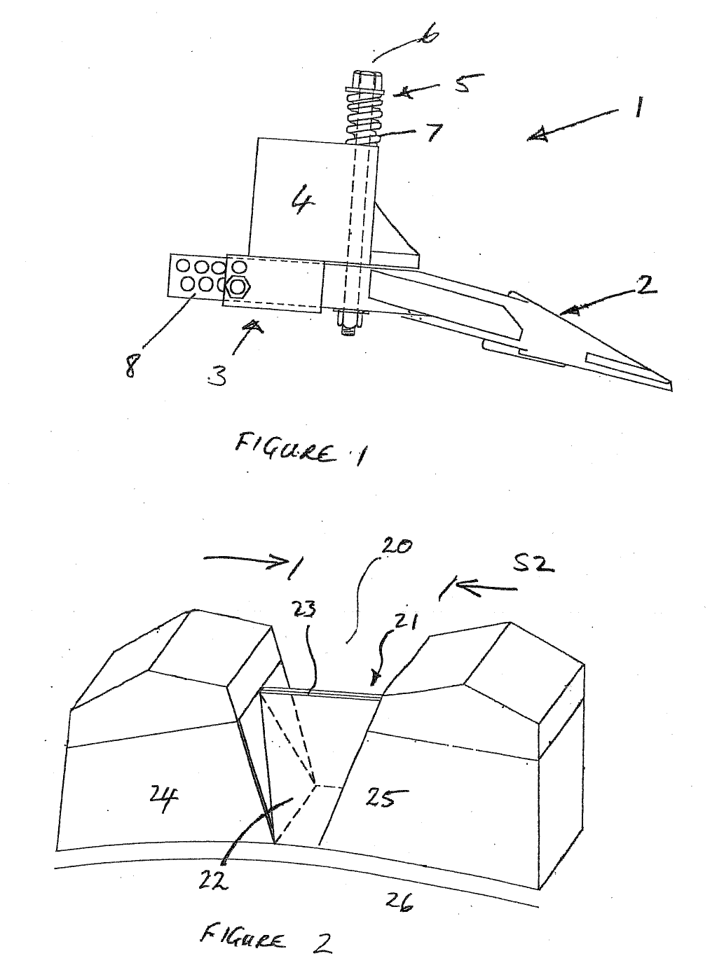

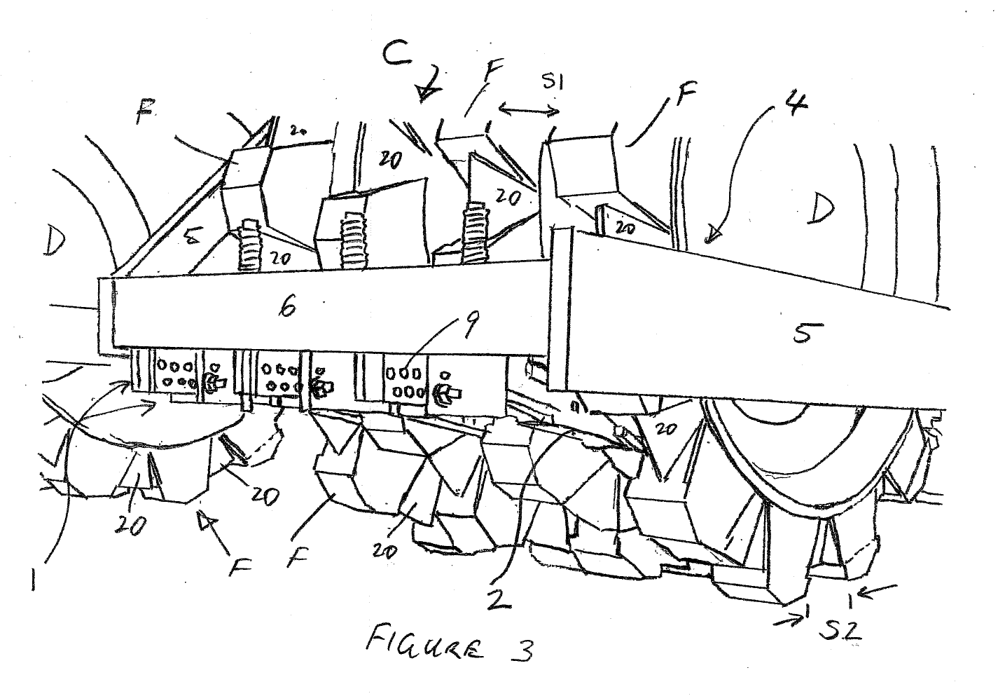

Different combinations of the cleaning apparatus 1 (either forward and/or rear cleaner portions) and/or the cleaning plate device with any other form of cleaning is possible such as offsetting the drums so the feet on the trailing drum land in place that has not been compacted by the leading drum or the pattern of feet can be specifically designed. The cleaning systems as disclosed at least should be able to reduce the formation of any unwanted soil or debris between feet in the rows or transversely to the rows.

The compactor cleaning system including apparatus and/or device may have at least one of the following advantages:
a) Less drag and less effort needed.
b) More efficient compacting.
c) Modest cost.
d) Simple installation.
e) Long wearing.
f) Adjustable.
g) More effective cleaning.
h) Efficient cleaning of a compactor.
i) Faster cleaning.
   Variations

Throughout the description of this specification, the word “comprise” and variations of that word such as “comprising” and “comprises”, are not intended to exclude other additives, components, integers or steps.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be limiting.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A compactor cleaning apparatus for a compactor having at least one drum/wheel having at least one drum/wheel with an outer surface or rim with spaced feet thereon, the cleaning apparatus including scraping means, supporting means, and hinging means whereby the scraping means is operatively connected or attached or joined to the supporting means and the supporting means is supported by the compactor via the hinging means, wherein the hinging means is constructed and adapted to allow the cleaning apparatus to move substantially vertically in a biasedly attached manner to remove at least some of the unwanted debris or soil between feet or on the drum surface.

2. A compactor cleaning apparatus as claimed in claim 1 wherein, the cleaner has an adjustment means to allow an adjustment of the distance from the scraping means to the drum/wheel rim surface.

3. A compactor cleaning apparatus as claimed in claim 2 wherein, the scraping means includes at least one blade.

4. A compactor cleaning apparatus as claimed in claim 3 wherein, the hinging means includes a bolt and spring attached to a compactor support beam frame.

5. A compactor cleaning apparatus as claimed in claim 4 wherein, the frame is rectangular in shape having side members, front member and rear member which frame is removably attached to a compactor drum/wheel at the sides.

6. A compactor cleaning apparatus as claimed in claim 5 wherein, the cleaning apparatus is attachable to the front member forming in use a leading scraper.

7. A compactor cleaning apparatus as claimed in claim 6 wherein, the cleaner apparatus is attached to the rear member forming in use a trailing scraper.

8. A compactor cleaning apparatus as claimed in claim 7 wherein, there is a plurality of cleaning apparatus on the front members and/or rear member of the frame.

9. A cleaning plate device comprising two plates joined together at one end and splayed apart at the other end whereby the said other end is joined to a compactor drum/wheel surface between at least two feet such that in use debris or soil has difficulty in remaining or forming between the feet of the compactor.

10. A compactor cleaning system comprising a compactor cleaning apparatus for a compactor having a drum/wheel and cleaning plate device whereby the cleaning apparatus having at least one drum/wheel with an outer surface or rim with spaced feet thereon, includes a scraping means, supporting means, and hinging means which are supported by a compactor via the hinging means whereby the scraping means is connected to the supporting means, wherein the hinging means is constructed and adapted to allow the cleaning apparatus to move vertically in a biased manner, each cleaning plate device includes comprising two plates joined together at one end and splayed apart at the other end whereby the said other end is joined to a compactor drum/wheel surface between at least two feet.

11. (canceled)

12. (canceled)

13. (canceled)
